(19) United States
(12) Patent Application Publication
(10) Pub. No.: US 2012/0013512 A1
(43) Pub. Date: Jan. 19, 2012

(54) Antenna device for vehicle remote control locking system

(75) Inventor: Huei Chi Wu, Tauyuan Hsien (TW)

(73) Assignee: Joymax Electronics Co., Ltd.

(21) Appl. No.: 12/804,199

(22) Filed: Jul. 16, 2010

(51) Int. Cl. H01Q 1/32

(52) U.S. Cl. 343/713

(57) ABSTRACT

An antenna device includes a housing having a base portion for attaching to a vehicle, and having a chamber formed in the housing and defined by a peripheral wall, and an antenna member engaged in the chamber of the housing and engaged within the peripheral wall of the housing and having a feed formed beside a groove, the antenna member is arranged to receive signals only from a predetermined direction for preventing the vehicle remote control locking system from being opened or unlocked with the signals from the other directions of the vehicle, the antenna member includes a ground terminal, and the groove of the antenna member is formed and located between the feed and the ground terminal.

### BACKGROUND OF THE INVENTION

1. Field of the Invention

The present invention relates to an antenna device for attaching onto various objects, and more particularly to an antenna device for attaching onto vehicles or other objects and for use with the vehicle remote control locking system and arranged for receiving signals from the predetermined direction and for preventing the vehicle remote control locking system from being opened or unlocked with the signals from the other directions of the vehicle.

2. Description of the Prior Art

Various kinds of typical multi-channel remote control transmitters have been developed and arranged for control of apparatus such as vehicle security systems, garage door openers and the like, and the transmitter provides the capability of selecting one of many different channels or codes to be transmitted with a minimum number of control switches.

For example, U.S. Pat. No. 4,890,108 to Droril et al. discloses one of the typical multi-channel remote control transmitters for use on vehicles and comprising a channel select switch and a transmit switch, and normally, a receiver is required to be attached or mounted or secured to the vehicle door for being actuated or operated by the remote control transmitter to lock or unlock the vehicle door.

However, normally, the receiver is arranged to receive the signals from various directions by the remote control transmitter; i.e., the remote control transmitter may transmit or emit signals from various directions to lock or unlock or control the vehicle door such that the vehicle door may be opened or unlocked by unauthorized persons from various directions.

U.S. Pat. No. 5,596,234 to Umeda et al. discloses another typical vehicle antenna device for a remote control device, and particularly discloses a method of disposing an antenna of a remote control device for a vehicle in which efficiency of the antenna becomes a predetermined value or more.

However, similarly, the receiver is arranged to receive the signals from various directions by the remote control device; i.e., the remote control device may transmit or emit signals from various directions to lock or unlock or control the vehicle door such that the vehicle door may be opened or unlocked by unauthorized persons from various directions.

U.S. Pat. No. 7,529,602 to Nagata et al. discloses a further typical vehicle-installed remote control unit comprising a receiver receiving a command signal transmitted from a transmitter dedicated to a vehicle, and a controller controlling a part of the vehicle in accordance with the command signal received by the receiver.

However, similarly, the receiver is arranged to receive the signals from various directions by the remote control device; i.e., the remote control device may transmit or emit signals from various directions to lock or unlock or control the vehicle door such that the vehicle door may be opened or unlocked by unauthorized persons from various directions.

The present invention has arisen to mitigate and/or obviate the afore-described disadvantages of the conventional antenna devices for vehicles.

### SUMMARY OF THE INVENTION

The primary objective of the present invention is to provide an antenna device for attaching onto vehicle doors or other objects and for use with the vehicle remote control locking system and arranged for receiving signals from the predetermined direction only and for preventing the vehicle remote control locking system from being opened or unlocked with the signals from the other directions of the vehicle.

In accordance with one aspect of the invention, there is provided an antenna device for a remote control vehicle, comprising a housing including a base portion for attaching to the vehicle, and including a chamber formed in the housing, and including a peripheral wall for forming the chamber of the housing, and an antenna member engaged in the chamber of the housing, and engaged within the peripheral wall of the housing, and including a groove formed therein, and including a feed provided on the antenna member, and arranged for allowing the antenna member to receive signals only from a predetermined direction and for preventing the vehicle remote control locking system from being opened or unlocked or actuated with the signals from the other directions of the vehicle.

The antenna member includes a ground terminal provided thereon. For example, the groove of the antenna member is preferably formed and located between the feed and the ground terminal for forming a radiating field on the upper portion of the peripheral wall of the housing or on the upper side of the antenna member, and thus for receiving the signals from the predetermined direction only, and thus for preventing the vehicle remote control locking system from being operated from the other directions of the vehicle.

The groove of the antenna member preferably includes an I-shaped structure. For example, the groove of the antenna member includes two opposite T-shaped slots and an intermediate longitudinal slot located between the T-shaped slots and communicative with the T-shaped slots for forming the I-shaped groove.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view illustrating an attachment of an antenna device in accordance with the present invention onto a vehicle;

FIG. 2 is a perspective view of the antenna device;

FIG. 3 is a partial exploded view of the antenna device;

FIG. 4 is another perspective view similar to FIG. 2, illustrating the operation of the antenna device;

FIG. 5 is a further perspective view illustrating the operation of the antenna device; and

FIG. 6 is a still further perspective view illustrating the operation of the antenna device.

### DETAILED DESCRIPTION OF THE PREFERRED EMBODIMENT

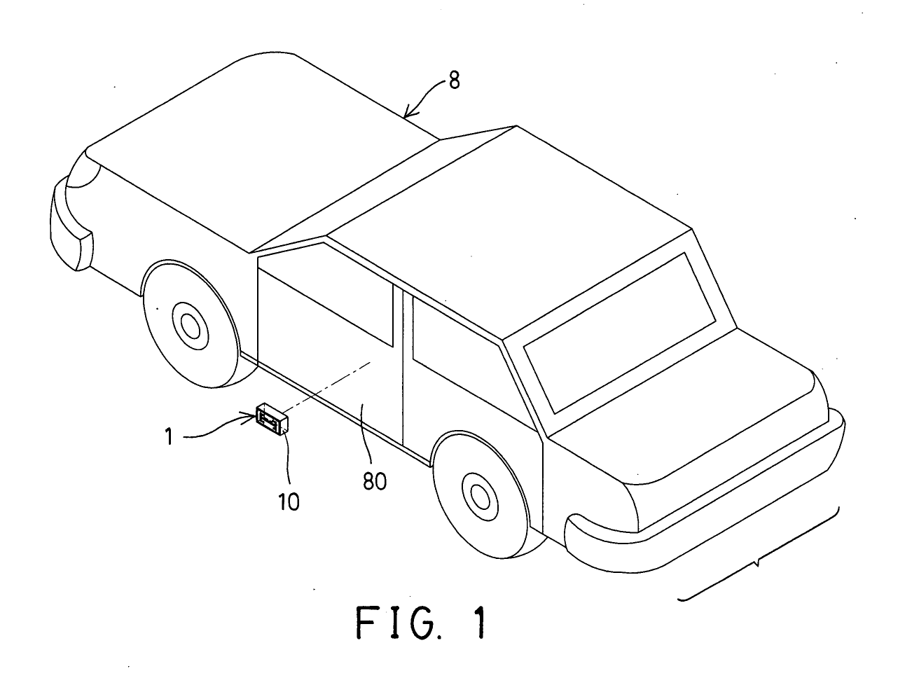

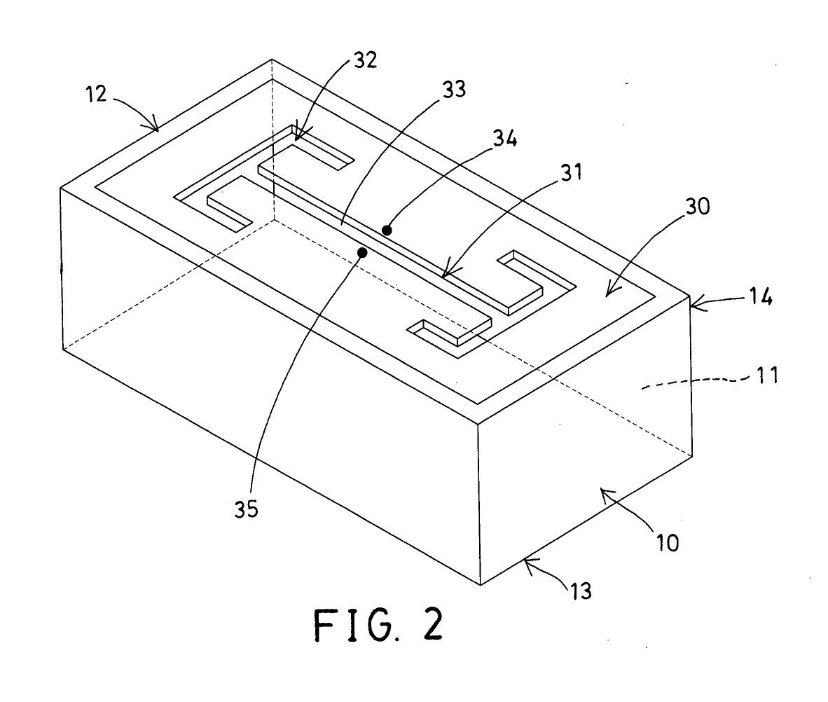

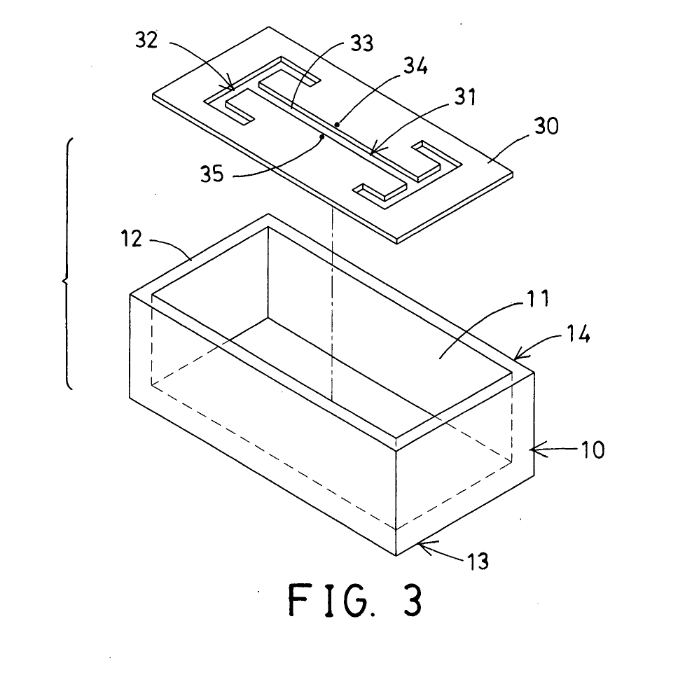

Referring to the drawings, and initially to FIG. 1, an antenna device 1 in accordance with the present invention is provided for attaching onto a vehicle 8 or other objects, such as for attaching to a vehicle door 80 of the vehicle 8 or the like with such as latches or fasteners (not shown), adhesive materials, or by welding processes or the like, and provided for use with the vehicle remote control locking system (not shown), and the antenna device 1 comprises a housing 10 (FIGS. 2-4) including a chamber 11 formed therein and formed or defined by an outer peripheral wall 12, and including a curved or planar bottom surface or base portion 13 for suitably attaching or mounting or securing onto the vehicle door 80 of the vehicle 8 or the like.

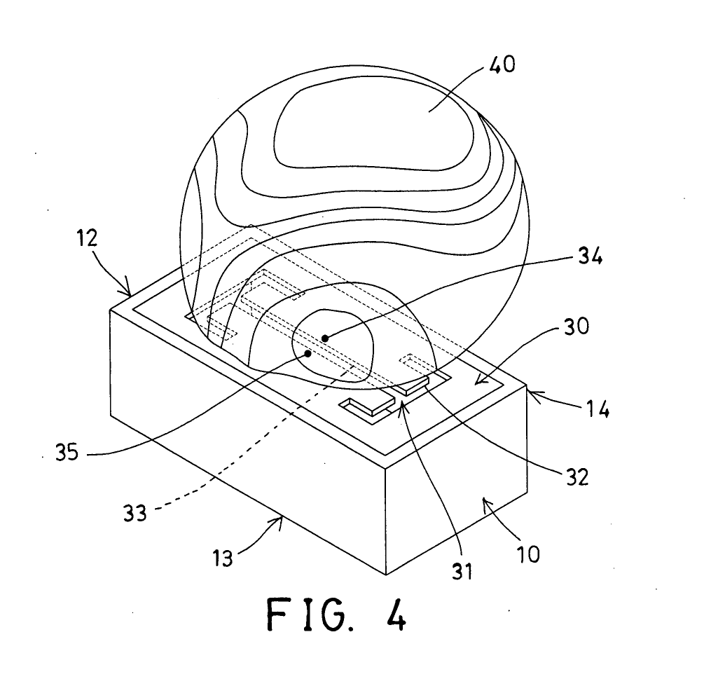

The antenna device 1 further includes an antenna member 30 provided for signal receiving and transmitting purposes, and having a shape identical to or corresponding to that of the chamber 11 or the peripheral wall 12 of the housing 10 for snuggly fitting or engaging into the chamber 11 of the housing 10 and for engaging with the opening portion or outer or upper portion 14 of the peripheral wall 12 of the housing 10, the antenna member 30 may be attached or mounted or secured to the upper portion 14 of the peripheral wall 12 of the housing 10 with such as latches or fasteners (not shown), adhesive materials, or by welding processes, or the like, for forming a radiating field 40 on the upper portion 14 or the predetermined portion of the peripheral wall 12 of the housing 10 (FIG. 4) or on the upper side of the antenna member 30.

The antenna member 30 includes an I-shaped groove 31 formed therein, and the groove 31 may include two opposite T-shaped slots 32 and an intermediate or middle or longitudinal slot 33 located between the T-shaped slots 32 and communicative with the T-shaped slots 32 for forming the I-shaped groove 31, and the antenna member 30 includes a feed 34 and a ground terminal 35 formed or provided thereon, and located on the opposite sides of the longitudinal slot 33, or the longitudinal slot 33 of the groove 31 of the antenna member 30 is formed and located between the feed 34 and the ground terminal 35.

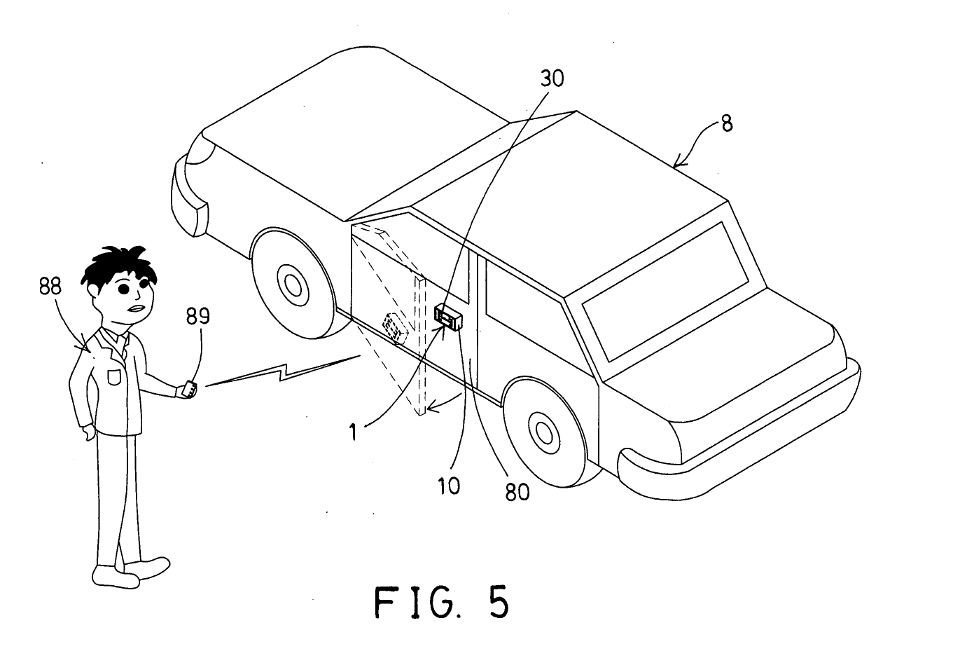

In operation, as shown in FIG. 4, the radiating field 40 of the antenna member 30 is formed and located on the upper portion 14 of the peripheral wall 12 of the housing 10 such that the antenna member 30 is particularly good for receiving the signals emitted from the predetermined direction, such as from the side of the vehicle door 80 of the vehicle 8, best shown in FIG. 5, and from the remote control transmitter 89 that is actuated or operated by the user 88.

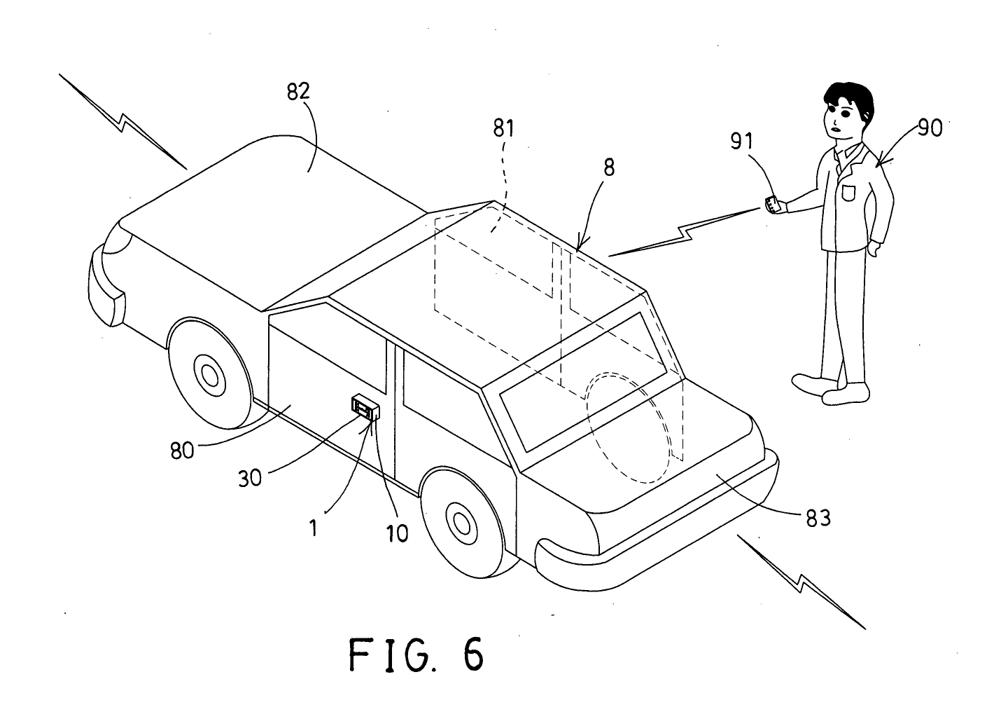

As shown in FIG. 6, when an unauthorized person 90 carries and actuates or operates a remote control transmitter 91 to emit signals from the other directions, such as from the side of the passenger door 81 of the vehicle 8, or from the front side 82 of the vehicle 8, or from the rear side 83 of the vehicle 8, the antenna member 30 may not receive the signals emitted from the remote control transmitter 91 such that the vehicle remote control locking system may not be actuated or operated by the remote control transmitter 91 from the passenger door 81 side or from the front side 82 or from the rear side 83 of the vehicle 8; i.e., the vehicle remote control locking system may be prevented from being opened or unlocked with the signals from the other directions.

It is to be noted that the antenna member 30 is engaged into the chamber 11 of the housing 10 and engaged within the upper portion 14 of the peripheral wall 12 of the housing 10, and surrounded by the peripheral wall 12 of the housing 10, such that the radiating field 40 of the antenna member 30 may be maintained on the upper portion 14 of the peripheral wall 12 of the housing 10 (FIG. 4), and such that the antenna member 30 may only receive the signals from the predetermined direction, such as from the side of the vehicle door 80 of the vehicle 8 (FIG. 5), and may not receive the signals from the other directions of the vehicle 8.

Accordingly, the antenna device in accordance with the present invention may be provided for attaching onto vehicles or other objects and for use with the vehicle remote control locking system and arranged for receiving signals from the predetermined direction and for preventing the vehicle remote control locking system from being opened or unlocked with the signals from the other directions of the vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna device for a remote control vehicle, comprising:
a housing including a base portion for attaching to the vehicle, and including a chamber formed in said housing, and including a peripheral wall for forming said chamber of said housing, and
an antenna member engaged in said chamber of said housing, and engaged within said peripheral wall of said housing, and including a groove formed therein, and including a feed provided on said antenna member, and arranged for allowing said antenna member to receive signals only from a predetermined direction.

2. The antenna device as claimed in claim 1, wherein said antenna member includes a ground terminal provided thereon.

3. The antenna device as claimed in claim 2, wherein said groove of said antenna member is formed and located between said feed and said ground terminal.

4. The antenna device as claimed in claim 1, wherein said groove of said antenna member includes an I-shaped structure.

5. The antenna device as claimed in claim 4, wherein said groove of said antenna member includes two opposite T-shaped slots and an intermediate longitudinal slot located between said T-shaped slots and communicative with said T-shaped slots for forming said I-shaped groove.
